(19) United States
(12) Patent Application Publication
(10) Pub. No.: US 2019/0391775 A1
(43) Pub. Date: Dec. 26, 2019

(54) PRINT-JOB GROUPING APPARATUS, PRINT-JOB PROCESSING SYSTEM, AND NON-TRANSITORY COMPUTER READABLE MEDIUM

(71) Applicant: FUJI XEROX CO., LTD., Tokyo (JP)

(72) Inventor: Kimihiko ISOBE, Kanagawa (JP)

(73) Assignee: FUJI XEROX CO., LTD., TOKYO (JP)

(21) Appl. No.: 16/442,553

(22) Filed: Jun. 17, 2019

(30) Foreign Application Priority Data
Jun. 26, 2018 (JP) 2018-120912

(51) Int. Cl. G06F 3/12

(52) U.S. Cl. CPC G06F 3/1262; G06F 3/1232; G06F 3/1211

(57) ABSTRACT

A print-job grouping apparatus includes a grouping unit that generates multiple group jobs by performing grouping based on multiple input print jobs in accordance with a grouping condition including a quality condition. Each group job is processed by a printer selected from multiple printers. The quality condition is a condition other than a general condition including a printing condition and is a special condition designated by a client requesting processing of each print job.

### CROSS-REFERENCE TO RELATED APPLICATIONS

This application is based on and claims priority under 35 USC 119 from Japanese Patent Application No. 2018-120912 filed Jun. 26, 2018.

### BACKGROUND

### (i) Technical Field

The present disclosure relates to print-job grouping apparatuses, print-job processing systems, and non-transitory computer readable media.

### (ii) Related Art

As paperless publishing and electronic publishing are becoming more and more common, large-scale print jobs, such as publishing of a large volume of copies, are decreasing in the printing industry. Thus, the operation rate of processing apparatuses for performing printing, including offset printers used for printing a large volume of copies, is decreasing, thus causing an increase in printing costs. In order to increase the operation rate of each processing apparatus, a so-called group job is drawing attention. A group job is processed as a large-scale print job by grouping together small-scale print jobs, which are normally printed in a small volume of copies. The group job is collectively processed in a selected printer.

For example, a plurality of print jobs for print results with identical sheet sizes and of identical sheet types (i.e., with identical printing conditions) are grouped together, so that a group job is generated. Alternatively, for example, a plurality of print jobs with similar deadlines (i.e., with substantially identical deadline conditions) are grouped together, so that a group job is generated. As another alternative, for example, print jobs for print results with identical delivery destinations (i.e., with identical delivery conditions) are grouped together, so that a group job is generated. See Japanese Unexamined Patent Application Publication No. 2018-55355 for an example.

### SUMMARY

Some print jobs have high demands from clients with respect to the quality of the print results. If a group job is generated by grouping together print jobs with various levels of demands for quality and is collectively processed, it may be difficult to satisfy the demands from the clients.

Aspects of non-limiting embodiments of the present disclosure relate to generation of a group job by performing grouping based on a plurality of print jobs, so that the demanded qualities from the clients requesting the processing of the print jobs may be finely dealt with.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a print-job grouping apparatus including a grouping unit that generates multiple group jobs by performing grouping based on multiple input print jobs in accordance with a grouping condition including a quality condition. Each group job is processed by a printer selected from multiple printers. The quality condition is a condition other than a general condition including a printing condition and is a special condition designated by a client requesting processing of each print job.

### BRIEF DESCRIPTION OF THE DRAWINGS

Exemplary embodiments of the present disclosure will be described in detail based on the following figures, wherein:

FIG. 1 schematically illustrates how each group job is generated based on a plurality of print jobs;

FIG. 2 is a block diagram illustrating an example of the configuration of a print-job processing system;

FIG. 3 illustrates an example of job management information;

FIGS. 4A and 4B illustrate examples of demanded quality attributes according to a first exemplary embodiment;

FIG. 5 illustrates an example of a demanded print quality of each component job according to the first exemplary embodiment;

FIG. 6 illustrates an example of a guaranteed print quality of each printer according to the first exemplary embodiment;

FIG. 7 illustrates an example of a demanded print quality of each component job according to a second exemplary embodiment;

FIG. 8 illustrates an example of a guaranteed print quality of each printer according to the second exemplary embodiment;

FIG. 9 illustrates an example of a demanded print quality and the demanded number of print pages according to a third exemplary embodiment;

FIG. 10 illustrates an example of a guaranteed print quality of each printer according to the third exemplary embodiment;

FIG. 11 schematically illustrates how each group job is generated based on a plurality of print jobs in accordance with a fourth exemplary embodiment; and

FIG. 12 illustrates an example of a demanded quality attribute of each print job according to a fifth exemplary embodiment.

### DETAILED DESCRIPTION

Exemplary embodiments of the present disclosure will be described below with reference to the drawings.

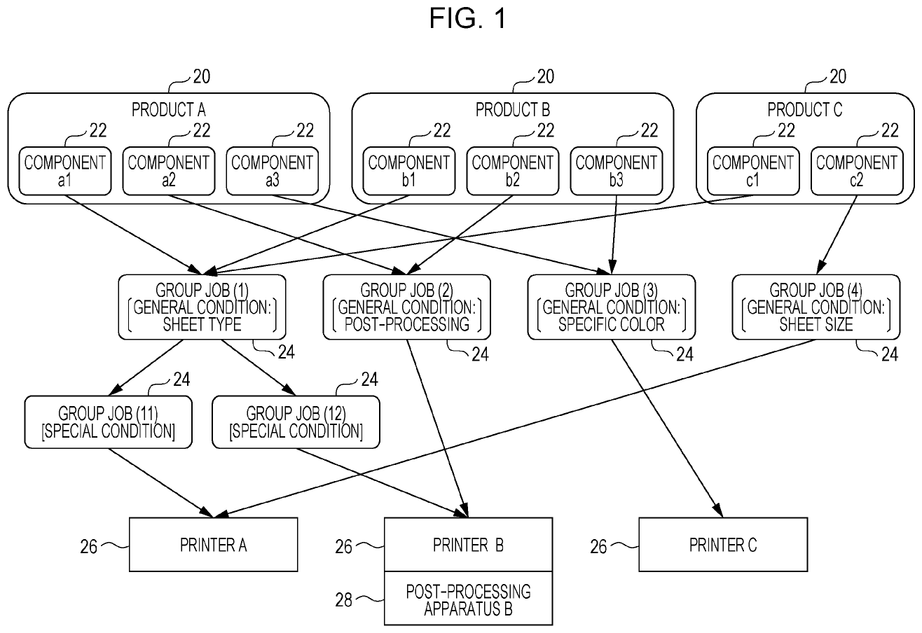

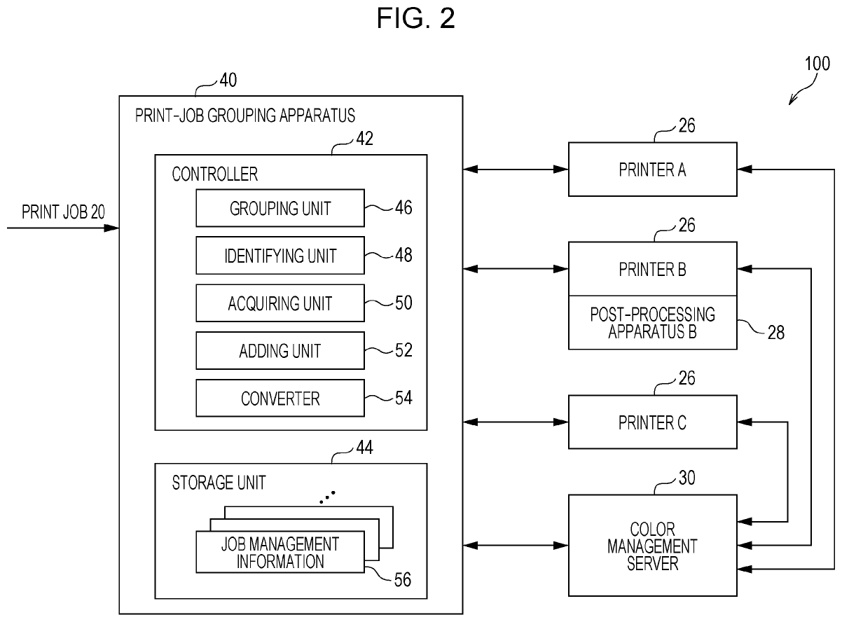

FIG. 1 schematically illustrates how each group job 24 is generated based on a plurality of print jobs 20. FIG. 2 is a block diagram illustrating an example of the configuration of a print-job processing system 100. First, the following description with reference to FIG. 1 relates to how the print jobs 20 are processed by the print-job processing system 100.

FIG. 1 illustrates three jobs (i.e., print jobs 20) for manufacturing products A, B, and C, respectively. Each print job 20 is based on a request from a client. Each product is, for example, a booklet, a catalog, a direct mail (DM), or a leaflet, and includes a plurality of components. For example, in a case where a product is a booklet, the booklet includes a “front cover”, “body text”, and a “belly-band”. Thus, as shown in FIG. 1, each print job 20 contains component jobs 22 corresponding to the respective components.

As shown in FIG. 1, one or more component jobs 22 contained in the plurality of print jobs 20 are grouped together in accordance with grouping conditions, whereby a plurality of group jobs 24 are generated. For example, FIG. 1 illustrates a state where a group job (2) is generated by grouping together a component job 22 for a component a2 of the product A and a component job 22 for a component b2 of the product B.

Then, each group job 24 is allocated to a printer selected from a plurality of printers, and a printing process is performed. For example, FIG. 1 illustrates a state where the group job (2) is allocated to a printer B.

Then, in printers A, B, and C, print results are obtained in units of group jobs 24. A print result (group print result) corresponding to each group job 24 is disassembled into components (component print results) corresponding to the component jobs 22, and the components are collected for each of the products A, B, and C, whereby the products A, B, and C are completed. Where necessary, each component is post-processed (such as cut and stapled), and the collected components are post-processed so as to be joined together. For example, the post-processing is performed by a post-processing apparatus 28 inline-connected to a printer 26 (e.g., a post-processing apparatus B inline-connected to the printer B in FIG. 1) or by an independent post-processing apparatus 28 (not shown). The term “inline-connected” refers to a state where a print output terminal of the printer 26 and an input terminal of the post-processing apparatus 28 are connected to each other.

A series of steps constituting a printed-material manufacturing process includes, for example, a document feeding step, a pre-processing (pre-pressing) step, a printing (pressing) step, a post-processing (post-pressing) step, and a delivery step. The generating process of each group job 24 described above is performed in the pre-processing step. The printing process by each printer is performed in the printing step, and the post-processing described above is performed in the post-processing step. The print-job processing system 100 according to an exemplary embodiment of the present disclosure is characterized in how each group job 24 is generated in the pre-processing step.

Next, an example of the configuration of the print-job processing system 100 will be described with reference to FIG. 2. The print-job processing system 100 includes a print-job grouping apparatus 40 that generates a plurality of group jobs based on a plurality of input print jobs 20, a plurality of printers 26, and a color management server 30 that manages the guaranteed print quality (color quality) of each printer 26.

The print-job grouping apparatus 40 is an information processing apparatus having a controller 42 and a storage unit 44. The controller 42 includes a processor, such as a central processing unit (CPU), and executes information processing in accordance with a program installed in the print-job grouping apparatus 40. Accordingly, the controller 42 functions as a grouping unit 46, an identifying unit 48, an acquiring unit 50, an adding unit 52, and a converter 54. The grouping unit 46 functions as grouping means, the identifying unit 48 functions as identifying means, the acquiring unit 50 functions as acquiring means, the adding unit 52 functions as adding means, and the converter 54 functions as converting means. The storage unit 44 is, for example, a hard disk and stores, for example, a program to be executed by the controller 42, a plurality of pieces of job management information 56 (job information) respectively corresponding to the plurality of print jobs 20, and print data of each print job 20. The print-job grouping apparatus 40 has a network interface (IF) as communication means (not shown), and is connected to the plurality of printers 26 and the color management server 30 via a network, such as a local area network (LAN) or the Internet. The print-job grouping apparatus 40 may also be regarded as a pre-processing apparatus since it is configured to perform the pre-processing step (i.e., a step previous to the printing step).

The program used in the print-job grouping apparatus 40 may be provided via the communication means, or may be provided by being stored in a computer-readable storage medium, such as a compact-disc read-only memory (CD-ROM) or a universal-serial-bus (USB) memory. The program provided via the communication means or from the storage medium is installed in the print-job grouping apparatus 40 (i.e., computer).

In the example shown in FIGS. 1 and 2, the plurality of printers 26 are digital printers (i.e., on-demand printers). Alternatively, the printers 26 may be offset printers or gravure printers. Some of the printers 26 may be inline-connected to the post-processing apparatus 28. As described above, the printer B is inline-connected to the post-processing apparatus B in FIGS. 1 and 2. Each printer 26 has a network interface (IF) as communication means (not shown) and is connected to the print-job grouping apparatus 40 and the color management server 30 via the network.

The color management server 30 shown in FIG. 2 is an information processing apparatus and has a controller (not shown) and a storage unit (not shown). The controller includes a processor, such as a CPU, and executes information processing in accordance with a program installed in the color management server 30. Accordingly, the color management server 30 manages the print quality of each printer 26. The storage unit is, for example, a hard disk and stores, for example, a program to be executed by the controller and management information related to the print quality of each printer 26. The color management server 30 has a network interface (IF) as communication means (not shown), and is connected to the printers 26 and the print-job grouping apparatus 40 via the network.

Although not shown, the print-job processing system 100 may be provided with a management apparatus that manages the printed-material manufacturing process. For example, the management apparatus may manage the manufacturing process and may manage the job management information 56 in place of the print-job grouping apparatus 40. Alternatively, the print-job grouping apparatus 40 may have the function of such a management apparatus.

Next, a process executed by the print-job grouping apparatus 40 will be described in detail. The print-job grouping apparatus 40 receives a plurality of print jobs 20. Each print job 20 contains print attributes and print data. The print attributes include, for example, information about the order number, the customer (client), the product name, the number of products, the product specifications, the delivery destination, the delivery deadline, the component name, and the component specifications. When the controller 42 of the print-job grouping apparatus 40 receives a print job 20, the controller 42 generates job management information 56 based on the print attributes of the print job 20 and stores the job management information 56 in the storage unit 44. Specifically, job management information 56 is generated for each print job 20 and is stored in the storage unit 44.

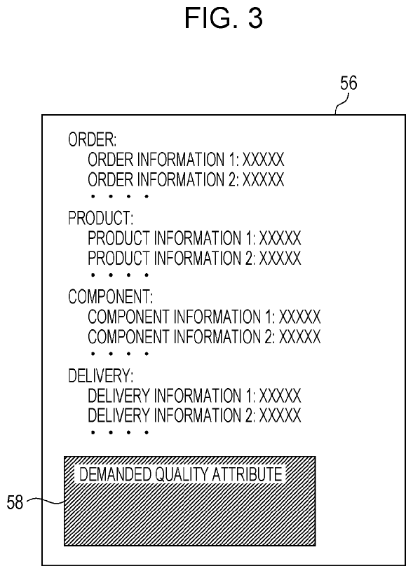

FIG. 3 illustrates an example of the job management information 56. The job management information 56 is data described in, for example, Extensible Markup Language (XML). As shown in FIG. 3, the job management information 56 has recorded therein order-related information, product-related information, component-related information, and delivery-related information. In addition, a demanded quality attribute 58 is also recorded in the job management information 56. The demanded quality attribute 58 includes a special quality-related condition (i.e., a quality condition or a preference condition) from the client requesting the processing of the print job 20. This quality condition is included in, for example, the print attributes of the print job 20, is identified by the identifying unit 48 of the print-job grouping apparatus 40, and is added as the demanded quality attribute 58 to the job management information 56 by the adding unit 52 of the print-job grouping apparatus 40.

Then, after receiving one or more print jobs 20, the print-job grouping apparatus 40 generates one or more group jobs 24 based on the print jobs 20. This will be described with reference to FIG. 1. In FIG. 1, three print jobs 20 for the products A, B, and C are received. It is assumed here that the products A, B, and C are booklets with different product specifications. The product A includes a component a1 (front cover), a component a2 (body text), and a component a3 (belly-band). The product B includes a component b1 (front cover), a component b2 (body text), and a component b3 (belly-band). The product C includes a component c1 (front cover) and a component c2 (belly-band). There is one component job 22 for each component. For example, similar to a print job 20, a component job 22 contains print attributes and print data.

The grouping unit 46 of the print-job grouping apparatus 40 generates a plurality of group jobs 24 by grouping together the component jobs 22 shown in FIG. 1 in accordance with the grouping conditions. The grouping conditions include general conditions and a quality condition (i.e., preference condition). The general conditions include printing conditions and may additionally include a deadline condition and a delivery condition. The printing conditions indicate the sheet size and the sheet type of a print result, whether or not a specific color (metallic ink or clear ink) is necessary, and whether or not post-processing is necessary. The deadline condition indicates, for example, the length of time to the deadline, such as whether the deadline is within one week or within two days. The delivery condition indicates whether the delivery destination is the same. The quality condition is a special condition designated by the client requesting the processing of the print job, and will be described in detail later.

The group jobs 24 corresponding to group jobs (1), (2), (3), and (4) shown in FIG. 1 are each generated by grouping together a plurality of component jobs 22 in accordance with the printing conditions (i.e., general conditions). The group job (1) is a group of component jobs 22 for the component a1 (front cover), the component b1 (front cover), and the component c1 (front cover) that correspond to a print result of the same sheet type (e.g., coated sheet). The group job (2) is a group of component jobs 22 corresponding to the component a2 (body text) and the component b2 (body text) that identically require post-processing. The group job (3) is a group of component jobs 22 corresponding to the component a2 (body text) and the component b2 (body text) that identically require a specific color. The group job (4) is a group job 24 directly corresponding to the component job 22 for the component c2 (belly-band) with reference to the sheet size.

The group job (1) is disassembled in accordance with the special condition (i.e., quality condition) from the client, so that a group job (11) and a group job (12) are generated. This will be described later.

After the group jobs 24 are generated, the controller 42 of the print-job grouping apparatus 40 allocates a printer to each group job 24. This process involves allocating a printer capable of processing the group job 24 to the group job 24. For example, because the group job (2) is a collection of component jobs 22 that require post-processing, the printer B connected to the post-processing apparatus 28 is allocated to the group job (2). Furthermore, because the group job (3) is a collection of component jobs 22 that require a specific color, the printer C capable of printing the specific color is allocated to the group job (3). The printer A capable of printing on a sheet having the size of the component c2 is allocated to the group job (4). In the printing step, the printers allocated to the respective group jobs 24 process the group jobs 24.

After the plurality of group jobs 24 are generated, the converter 54 of the print-job grouping apparatus 40 converts each group job 24 into one print job. This involves, for example, generating a single print attribute based on the print attributes of the plurality of component jobs 22 and combining the print data of the plurality of component jobs 22 into a single piece of print data. Thus, each group job may be processed in the printing step by regarding the group job as one print job. For example, in each printer 26, the component jobs 22 are processed collectively with no intervals (i.e., no idle time) therebetween, thereby increasing the operation rate of each printer 26.

Some products (including components) require high quality demands from the client (i.e., demands from the client requesting the processing of print jobs). If the grouping is performed in accordance with the general condition alone such that the group jobs 24 are generated and collectively processed, it may sometimes be difficult to satisfy the client's demands. The print-job grouping apparatus 40 according to the exemplary embodiment of the present disclosure performs grouping also in view of the special condition (quality condition) from the client. As shown in FIG. 1, grouping is performed from the group job (1) in accordance with the special condition, so that the group job (11) and the group job (12) are generated. Although the group job (11) and the group job (12) are generated via the group job (1) in FIG. 1, the group job (11) and the group job (12) may alternatively be generated without the intervention of the group job (1). Furthermore, although the group jobs (2), (3), and (4) are not grouped in accordance with the special condition in FIG. 1, these group jobs may also be grouped in accordance with the special condition.

An example of special condition (quality condition) is a print quality condition. There are a plurality of exemplary embodiments, which will be described below, with regard to grouping of the component jobs 22 in accordance with the print quality condition. These exemplary embodiments will be described below.

### First Exemplary Embodiment

The client may sometimes designate a print quality rank (i.e., image quality rank, quality rank) to each product or each component. Specifically, a “high” image quality may be designated to a certain product or component, whereas a “low” image quality may be designated to another product or component. For example, a case where a “low” image quality is permissible corresponds to a case where the client prioritizes cost over quality and desires to avoid an excessive quality and reduce the cost. In the first exemplary embodiment, the component jobs 22 are grouped together while the image quality rank designated to each product or component by the client is set as the quality condition, thereby generating the group jobs 24.

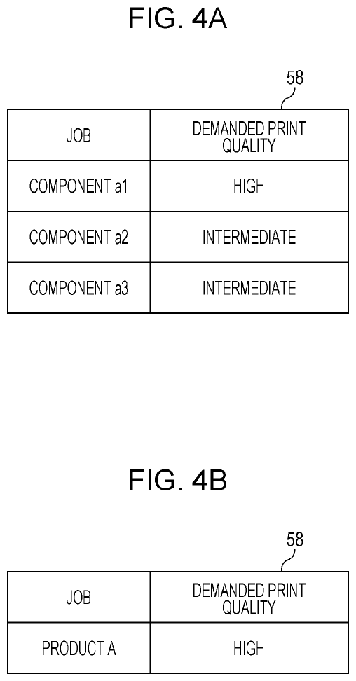

FIG. 4A illustrates an example of image quality ranks (demanded print qualities) corresponding to the components a1, a2, and a3 of the product A shown in FIG. 1. Each image quality rank is designated to the corresponding component by the client and is a quality condition recorded as the demanded quality attribute 58 of the job management information 56 (see FIG. 3). For example, an image quality rank is recorded in the print attributes of the print job 20 for the product A based on a designation by the client, the identifying unit 48 of the print-job grouping apparatus 40 identifies this image quality rank from the print attributes, and the adding unit 52 of the print-job grouping apparatus 40 records (adds) the image quality rank as the demanded quality attribute 58 in the job management information 56. Alternatively, for example, an operator inputs the image quality rank designated by the client from an input unit (such as a keyboard or a mouse) connected to the print-job grouping apparatus 40 or from an input unit of a client terminal (not shown) connected to the print-job grouping apparatus 40 via the network. Then, the adding unit 52 of the print-job grouping apparatus 40 records the input image quality rank as the demanded quality attribute 58 in the job management information 56. Accordingly, if the operator inputs an image quality rank, the setting process for the image quality rank is flexibly performed. The recording of a quality condition as the demanded quality attribute 58 in the job management information 56 by identifying or inputting the quality condition in this manner is the same in other exemplary embodiments to be described hereinafter.

As shown in FIG. 4B, an image quality rank is sometimes designated by the client to each product instead of each component. In such a case, the image quality rank designated to the product is succeeded to each component included in the product. Specifically, for example, if a “high” image quality is designated to the product A, as shown in FIG. 4B, the components a1, a2, and a3 included in the product A are treated such that the “high” image quality is designated to each of the components. The succeeding of a quality condition of a product to a component in this manner is the same in other exemplary embodiments to be described hereinafter.

The grouping unit 46 of the print-job grouping apparatus 40 groups together the component jobs 22 in view of the image quality ranks of the components, thereby generating each group job 24. The following description relates to an example where the group job (11) and the group job (12) are generated from the group job (1) shown in FIG. 1 by further performing grouping in accordance with the image quality ranks.

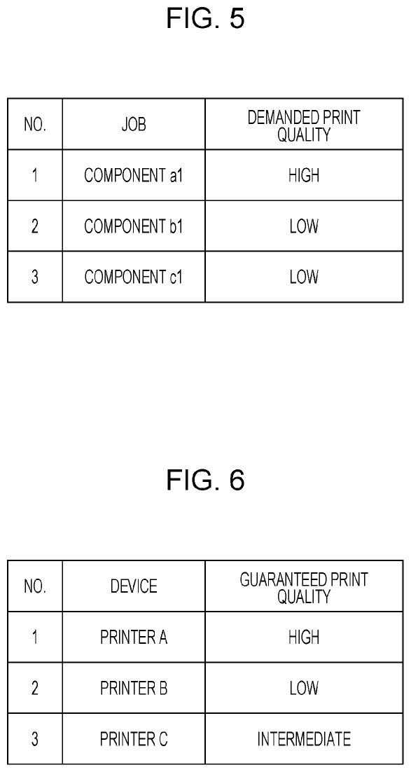

FIG. 5 illustrates an example of image quality ranks corresponding to the component jobs 22 for the component a1 (front cover), the component b1 (front cover), and the component c1 (front cover) constituting the group job (1) in FIG. 1. Examples of the types of image quality ranks include “low”, “intermediate”, and “high” ranks. The information in FIG. 5 is acquired by the controller 42 of the print-job grouping apparatus 40 reading the demanded quality attribute 58 of the job management information 56 for each of the products A, B, and C. In FIG. 5, the component a1 has a “high” image quality rank, the component b1 has a “low” image quality rank, and the component c1 has a “low” image quality rank.

FIG. 6 illustrates an example of guaranteed print qualities corresponding to the printers A, B, and C. Similar to the image quality ranks in FIG. 5, examples of the types of guaranteed print qualities include “low”, “intermediate”, and “high” guaranteed print qualities. A printer corresponding to a “high” print quality is capable of printing with a “high” image quality, a printer corresponding to an “intermediate” quality is capable of printing with an “intermediate” image quality, and a printer corresponding to a “low” image quality. For example, the guaranteed print qualities of the printers A, B, and C are managed by the color management server 30 (see FIG. 2). The acquiring unit 50 of the print-job grouping apparatus 40 acquires the guaranteed print qualities via the network. The guaranteed print qualities of the printers A, B, and C may sometimes change. For example, the guaranteed print qualities may change before and after a large number of pages are printed. The color management server 30 manages such changeable guaranteed print qualities of the printers A, B, and C. Because the guaranteed print qualities change in this manner, the acquiring unit 50 of the print-job grouping apparatus 40 desirably acquires the guaranteed print qualities from the color management server 30 at predetermined intervals. In FIG. 6, the printer A prints with a “high” guaranteed print quality, the printer B prints with a “low” guaranteed print quality, and the printer C prints with an “intermediate” guaranteed print quality.

For example, in a case where the component jobs 22 for the components a1, b1, and c1 are grouped into the group job (1) and the group job (1) is processed by the printer B with the “low” guaranteed print quality shown in FIG. 6, it is difficult to satisfy the condition (demand) for the component a1 with the “high” image quality rank shown in FIG. 5 (i.e., insufficient quality). In a case where the group job (1) is processed by the printer A with the “high” guaranteed print quality shown in FIG. 6, an excessive quality is obtained with respect to each of the component b1 and the component c1 with the “low” image quality rank shown in FIG. 6.

The grouping unit 46 of the print-job grouping apparatus 40 performs grouping in accordance with the image quality ranks of the component jobs 22 for the components a1, b1, and c1 and the guaranteed print qualities of the printers A, B, and C. The component job 22 for the component a1 with the “high” image quality rank is set as one group job (group job (11)), and the group job (11) is allocated to and processed by the printer A with the “high” guaranteed print quality. Moreover, the component jobs 22 for the components b1 and c1 with the “low” image quality rank are grouped into one group job (group job (12)), and the group job (12) is allocated to and processed by the printer B with the “low” guaranteed print quality. Accordingly, the insufficient quality and the excessive quality described above may be prevented.

According to the first exemplary embodiment described above, a plurality of group jobs 24 are generated by grouping together a plurality of component jobs 22, so that the demanded image qualities (image quality ranks) from the client requesting the print jobs may be finely dealt with. The print results may match the demanded image qualities from the client. Furthermore, by acquiring the guaranteed print quality of each printer at predetermined intervals, as described above, the grouping is performed properly even if the guaranteed print qualities of the printers change over time, so that the print result in each printer may match the demanded image quality from the client.

### Second Exemplary Embodiment

Next, a second exemplary embodiment will be described. In the second exemplary embodiment, a color difference that may be permitted (referred to as “permissible color difference” hereinafter) in the print result of each product or component is used as the quality condition in place of the image quality rank in the first exemplary embodiment. The client designates a permissible color difference as the quality condition for each product or component.

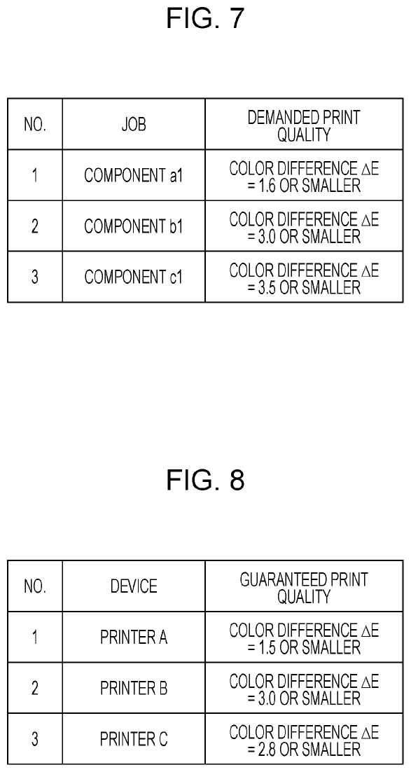

FIG. 7 illustrates an example of permissible color differences (demanded print qualities) corresponding to the component jobs 22 for the component a1 (front cover), the component b1 (front cover), and the component c1 (front cover) constituting the group job (1) in FIG. 1. These permissible color differences are recorded in the job management information 56 for the products A, B, and C as the demanded quality attributes 58. In FIG. 7, the component a1 has a permissible color difference of 1.6 or smaller, the component b1 has a permissible color difference of 3.0 or smaller, and the component c1 has a permissible color difference of 3.5 or smaller.

FIG. 8 illustrates an example of guaranteed print qualities corresponding to the printers A, B, and C. In FIG. 8, a guaranteed print quality is a color difference guaranteed (referred to as “guaranteed color difference” hereinafter) when printing is performed by a printer. The guaranteed color differences of the printers A, B, and C are managed by the color management server 30 (see FIG. 2). The acquiring unit 50 of the print-job grouping apparatus 40 acquires the guaranteed color differences via the network. Similar to the first exemplary embodiment, since the guaranteed color differences of the printers A, B, and C may change over time, the acquiring unit 50 of the print-job grouping apparatus 40 desirably acquires the guaranteed color differences at predetermined intervals. In FIG. 8, the printer A has a guaranteed color difference of 1.5 or smaller, the printer B has a guaranteed color difference of 3.0 or smaller, and the printer C has a guaranteed color difference of 2.8 or smaller.

For example, in a case where the component jobs 22 for the components a1, b1, and c1 are grouped into the group job (1) and the group job (1) is processed by the printer B with the guaranteed color difference of “3.0 or smaller” shown in FIG. 8, it is difficult to satisfy the condition (demand) for the component a1 with the permissible color difference (quality condition) of “1.6 or smaller” shown in FIG. 7 (insufficient quality). In a case where the group job (1) is processed by the printer A with the permissible color difference of “1.5 or smaller” shown in FIG. 8, an excessive quality is obtained with respect to each of the component b1 with the permissible color difference of “3.0 or smaller” and the component c1 with the permissible color difference of “3.5 or smaller” shown in FIG. 7.

The grouping unit 46 of the print-job grouping apparatus 40 performs grouping in accordance with the permissible color differences (demanded print qualities) of the component jobs 22 for components a1, b1, and c1 and the guaranteed color differences (guaranteed print qualities) of the printers A, B, and C. The component job 22 for the component a1 with the permissible color difference of “1.6 or smaller” is set as one group job (group job (11)), and the group job (11) is allocated to and processed by the printer A with the guaranteed color difference of “1.5 or smaller”. Moreover, the component job 22 for the component b1 with the permissible color difference of “3.0 or smaller” and the component job 22 for the component c1 with the permissible color difference of “3.5 or smaller” are grouped into one group job (group job (12)), and the group job (12) is allocated to and processed by the printer B with the guaranteed color difference of “3.0 or smaller”. Accordingly, the insufficient quality and the excessive quality described above may be prevented.

According to the second exemplary embodiment described above, a plurality of group jobs 24 are generated by grouping together a plurality of component jobs 22, so that the demanded image qualities (permissible color differences) from the client requesting the print jobs may be finely dealt with, similarly to the first exemplary embodiment. The print results may match the demanded image qualities from the client. Furthermore, by acquiring the guaranteed color difference of each printer at predetermined intervals, as described above, the grouping is performed properly even if the guaranteed color differences of the printers change over time, so that the print result in each printer may match the demanded image quality from the client.

### Third Exemplary Embodiment

Next, a third exemplary embodiment will be described. The third exemplary embodiment is similar to the second exemplary embodiment in that the permissible color differences are set as the quality conditions and the component jobs 22 are grouped together in accordance with the permissible color differences, but differs from the second exemplary embodiment in that the grouping is performed also in view of the number of pages to be printed. As mentioned above, the print quality of a printer may change before and after a large number of pages are printed. There may be a case where a print result obtained toward the end of a printing process may be printed with a color largely deviated from a desired color. In other words, a color variation or a missing color may occur. A color difference value may increase with increasing number of print pages. In the third exemplary embodiment, guaranteed-color-difference information according to the number of pages to be printed by a printer is acquired, and the grouping is performed such that the permissible color difference (quality condition) of the client is satisfied.

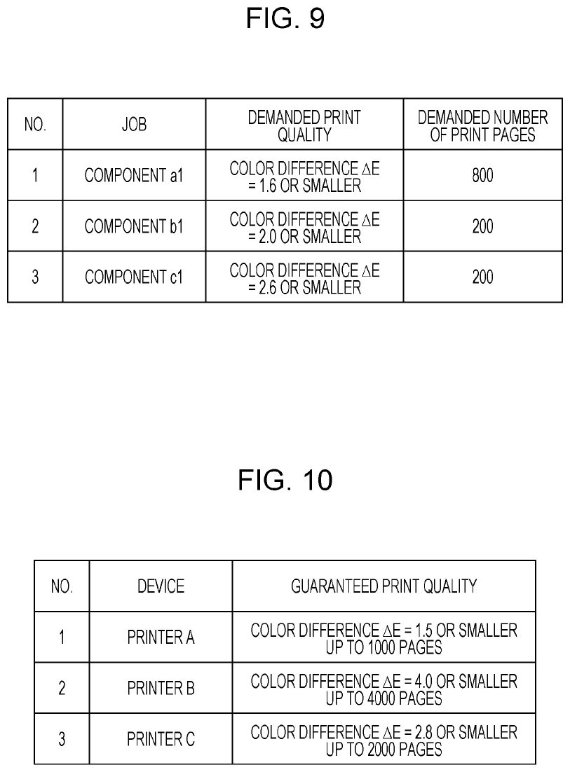

FIG. 9 illustrates an example of permissible color differences (demanded print qualities) and the demanded number of print pages corresponding to the component jobs 22 for the component a1 (front cover), the component b1 (front cover), and the component c1 (front cover) constituting the group job (1) in FIG. 1. The permissible color differences and the demanded number of print pages are recorded in the job management information 56 for the products A, B, and C as the demanded quality attributes 58. The demanded number of print pages is identified by the identifying unit 48 of the print-job grouping apparatus 40 from, for example, the print attributes of each print job 20, and is recorded as the demanded quality attribute 58 in the job management information 56 by the adding unit 52 of the print-job grouping apparatus 40. In FIG. 9, the component a1 has a permissible color difference of 1.6 or smaller and 800 pages as the demanded number of print pages, the component b1 has a permissible color difference of 2.0 or smaller and 200 pages as the demanded number of print pages, and the component c1 has a permissible color difference of 2.6 or smaller and 200 pages as the demanded number of print pages.

FIG. 10 illustrates an example of guaranteed print qualities corresponding to the printers A, B, and C. A guaranteed print quality is a guaranteed color difference according to the number of print pages. FIG. 10 indicates that the printer A is “capable of performing printing with a guaranteed color difference of 1.5 or smaller if the printing is up to 1000 pages”, the printer B is “capable of performing printing with a guaranteed color difference of 4.0 or smaller if the printing is up to 4000 pages”, and the printer C is “capable of performing printing with a guaranteed color difference of 2.8 or smaller if the printing is up to 2000 pages”. For example, in the printer A, printing with a color difference of 1.5 or smaller is not guaranteed for the 1001-th page, but a calibration is performed on the printer A prior to the printing of the 1001-th page, so that the printer A again becomes “capable of performing printing with a guaranteed color difference of 1.5 or smaller if the printing is up to 1000 pages”. The guaranteed color difference according to the number of print pages by each of the printers A, B, and C is managed by the color management server 30 (see FIG. 2). The acquiring unit 50 of the print-job grouping apparatus 40 acquires the guaranteed color differences via the network. Similar to the first and second exemplary embodiments, since the guaranteed color difference according to the number of print pages by each of the printers A, B, and C changes over time, the acquiring unit 50 of the print-job grouping apparatus 40 acquires the guaranteed color difference (guaranteed print quality) according to the number of print pages at predetermined intervals.

As shown in FIG. 9, since the permissible color differences of the component jobs 22 for the components a1, b1, and c1 are 1.6 or smaller, 2.0 or smaller, and 2.6 or smaller in the order, respectively, if the component jobs 22 are processed by the printer B with the guaranteed color difference of 4.0 or smaller or by the printer C with the guaranteed color difference of 2.8 or smaller, both components would result in insufficient qualities. Thus, these component jobs are processed by the printer A. In that case, for example, if the component jobs 22 for the components a1, b1, and c1 are grouped into the group job (1), the total number of print pages for the group job (1) becomes 1200 pages (=800+200+200). When this group job (1) is allocated to the printer A, the number of print pages exceeds 1000 pages prescribed in the printer A (1000<1200). Thus, it is difficult to satisfy the permissible color difference of any one of the component jobs 22 for the components a1, b1, and c1 (insufficient quality).

The grouping unit 46 of the print-job grouping apparatus 40 performs grouping in accordance with the permissible color differences (demanded print qualities) and the demanded number of print pages of the component jobs 22 for the components a1, b1, and c1, and the permissible color differences (guaranteed print qualities) according to the number of pages to be printed by the printers A, B, and C. For example, a component job 22 for a component a1 with a demanded number of print pages of “800 pages” is set as one group job (i.e., a group job (11)). Moreover, component jobs 22 for a component b1 with a demanded number of print pages of “200 pages” and a component c1 with a demanded number of print pages of “200 pages” are grouped into one group job (i.e., a group job (12) with 400 pages as a total number of pages). Accordingly, group jobs 24 are generated such that the total number of pages does not exceed 1000 pages prescribed in the printer A. Then, the printer A is allocated to the group job (11), and a printing process is performed therein. Subsequently, the printer A is calibrated. Consequently, the printer A again becomes “capable of performing printing with a guaranteed color difference of 1.5 or smaller if the printing is up to 1000 pages”. Then, the printer A is allocated to the group job (12), and a printing process is performed therein. Consequently, an insufficient quality and an excessive quality with respect to the permissible color differences (demanded image qualities) from the client may be prevented.

The third exemplary embodiment described above is similar to the first and second exemplary embodiments in that a plurality of group jobs 24 are generated by grouping together a plurality of component jobs 22 such that the demanded image qualities (permissible color differences) from the client requesting the print jobs may be finely dealt with. Since the grouping is performed in view of the guaranteed print quality according to the number of print pages guaranteed by each of the plurality of printers, a print result that more reliably matches the demanded image quality from the client may be obtained.

### Fourth Exemplary Embodiment

Next, a fourth exemplary embodiment will be described. Although the component jobs 22 are grouped together as elements in the above description, the print jobs 20 may alternatively grouped together as elements. For example, if the products are “leaflets”, for example, each product is one sheet of paper, and each print job 20 is a job in which a plurality of sheets are to be printed. Such a print job 20 does not have component jobs 22. In the fourth exemplary embodiment, a group job 24 is generated by grouping together print jobs 20 as elements.

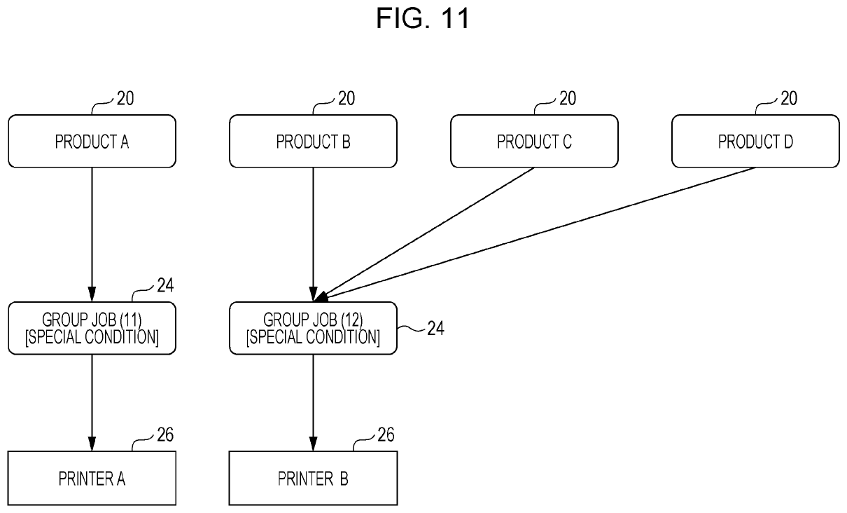

FIG. 11 illustrates how each group job 24 is generated by grouping together print jobs 20 as elements. In the example in FIG. 11, in accordance with a special condition (quality condition) from the client requesting the processing of each print job 20, the print job 20 for the product A is set as one group job (group job (11)), and the three print jobs 20 for the products B, C, and D are grouped together into another group job (group job (12)). Then, the printer A is allocated to the group job (11), and a printing process is performed therein. Moreover, the printer B is allocated to the group job (12), and a printing process is performed therein. The grouping of the print jobs 20 according to the special condition (quality condition) in FIG. 11 is performed based on a method similar to those in the first to third exemplary embodiments described above.

For example, if the plurality of printers 26 have the same function, the grouping may be performed in accordance with the special condition (quality condition) alone without taking into consideration the general conditions, as in FIG. 11. The same applies to a case where the component jobs 22 are grouped together as elements, as described above. For example, even if the printers 26 have the same function, the guaranteed print qualities thereof may change over time, as described above. In that case, the grouping is performed in accordance with the guaranteed print quality of each printer 26 and the special condition (quality condition).

Even in a case where each print job 20 contains a component job or jobs 22, the print jobs 20 may be grouped together as elements. However, the grouping may be performed more finely when the component jobs 22 are grouped together as elements rather than when the print jobs 20 are grouped together as elements. Furthermore, although not shown, each group job 24 may be generated by grouping together a mixture of a print job or jobs 20 and a component job or jobs 22.

### Fifth Exemplary Embodiment

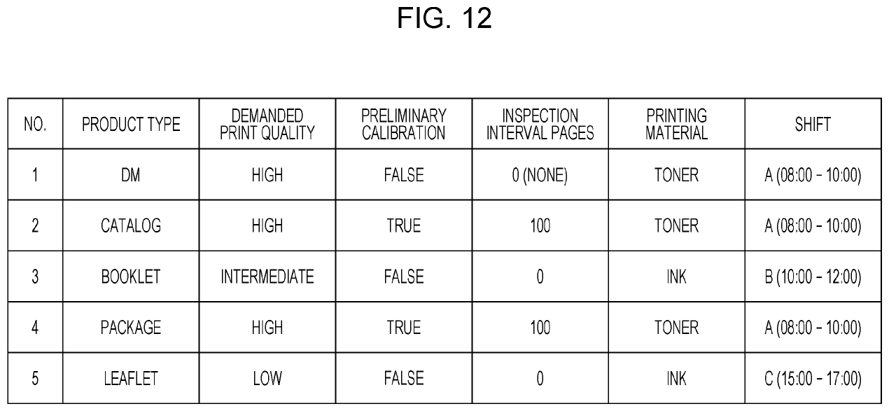

Next, a fifth exemplary embodiment will be described. The fifth exemplary embodiment differs from the first to fourth exemplary embodiments in that the quality conditions designated by the client are indirectly used as the grouping conditions. New conditions for grouping are generated (set) based on the quality conditions designated by the client, and the print jobs 20 are grouped together in accordance with the conditions (referred to as “set conditions” hereinafter). FIG. 12 illustrates image quality ranks (demanded print qualities, quality conditions) of five print jobs (Nos. 1 to 5) and the set conditions.

Information designated by the client includes “product type” and “demanded print quality” (quality condition). The “product type” and the “demanded print quality” are recorded as the demanded quality attribute 58 in the job management information 56 (see FIG. 3) of each print job 20. Then, for each print job 20, pieces of information about “preliminary calibration”, “inspection interval pages”, “printing material”, and “shift” items serving as the set conditions are automatically generated by the controller 42 of the print-job grouping apparatus 40 based on the “demanded print quality”, and the adding unit 52 of the print-job grouping apparatus 40 adds the information to the demanded quality attribute 58 of the job management information 56. The set conditions recorded in the demanded quality attribute 58 in this manner are changeable by, for example, an operator operating the print-job grouping apparatus 40. In FIG. 12, the set conditions for each print job 20 after being changed by an operator are shown.

The “preliminary calibration” item indicates whether a printer is to be calibrated (true) or not (false) prior to printing. The “inspection interval pages” item indicates the number of pages between which an inspection is performed for checking whether or not there is a problem in a print result. When the number is “0”, the inspection is not performed, or when the number is “100”, for example, the inspection is performed at intervals of 100 pages. The “printing material” item indicates a recording material used for printing. The “shift” item indicates a printing time frame. For example, a printer may be capable of performing printing with reduced color variations in an early-morning time frame. Therefore, the “shift” item is provided as one of the set conditions. The set conditions shown in FIG. 12 are an example and may include another condition as an additional set condition.

The grouping unit 46 of the print-job grouping apparatus 40 reads the information in FIG. 12 (i.e., the demanded quality attribute 58 of the job management information 56 of each print job 20), and groups together, for example, print jobs 20 with identical contents with respect to the “preliminary calibration”, “inspection interval pages”, “printing material”, and “shift” items serving as the set conditions, so as to generate group jobs 24. Although the print jobs 20 are group together as elements in this case, the set conditions may be generated with component jobs 22 as elements, and the component jobs 22 may be grouped together as elements.

According to the fifth exemplary embodiment described above, the print jobs 20 or the component jobs 22 are grouped together in accordance with the set conditions (such as the “preliminary calibration”, “inspection interval pages”, “printing material”, and “shift” items) generated based on the quality conditions designated by the client and adjusted by, for example, an operator, so that group jobs 24 are generated. The grouping is adjustable by, for example, an operator, whereby the grouping may be performed more finely.

### Other Exemplary Embodiments

In the above description, the special condition (quality condition) designated by the client is a print quality condition. Alternatively, the quality condition may be, for example, a post-processing quality condition or a delivery quality condition. For example, a post-processing quality condition may include a permissible displacement-amount value from a reference position designated by the client for, for example, cutting or stapling. This permissible value is recorded as the demanded quality attribute 58 of the job management information 56 (FIG. 3) described above. The print-job grouping apparatus 40 reads the demanded quality attribute 58 (permissible value) of each print job, groups together component jobs 22 for components with small designated permissible values (components requiring high quality) into one group job 24, and allocates the group job 24 to a high-accuracy post-processing apparatus. On the other hand, component jobs 22 for components with large designated permissible values (which may be low quality) may be grouped into one group job 24, and the group job 24 may be allocated to a post-processing apparatus that may process the group job 24 at low cost. Then, each group job is processed by the corresponding allocated post-processing apparatus. Accordingly, in post-processing, an insufficient quality and an excessive quality of a product may be avoided with respect to a demand designated by the client.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A print-job grouping apparatus comprising:
a grouping unit that generates a plurality of group jobs by performing grouping based on a plurality of input print jobs in accordance with a grouping condition including a quality condition,
wherein each group job is processed by a printer selected from a plurality of printers, and
wherein the quality condition is a condition other than a general condition including a printing condition and is a special condition designated by a client requesting processing of each print job.

2. The print-job grouping apparatus according to claim 1,
wherein the grouping condition includes the general condition and the quality condition.

3. The print-job grouping apparatus according to claim 1,
wherein the quality condition includes a quality rank.

4. The print-job grouping apparatus according to claim 1,
wherein the quality condition includes a print quality condition.

5. The print-job grouping apparatus according to claim 4, further comprising:
an identifying unit that identifies a demanded print quality of each of the print jobs as the quality condition,
wherein the grouping unit generates the plurality of group jobs by grouping together the plurality of print jobs in accordance with the demanded print quality of each of the print jobs and a guaranteed print quality guaranteed by each of the printers.

6. The print-job grouping apparatus according to claim 4, further comprising:
an identifying unit that identifies a demanded print quality of each of the print jobs as the quality condition and identifies a demanded number of print pages for each of the print jobs,
wherein the grouping unit generates the plurality of group jobs by grouping together the plurality of print jobs in accordance with the demanded print quality of each of the print jobs, the demanded number of print pages, and a guaranteed print quality according to a number of print pages guaranteed by each of the printers.

7. The print-job grouping apparatus according to claim 4,
wherein each of the print jobs includes a plurality of component jobs, and
wherein the grouping unit generates the plurality of group jobs by grouping together the component jobs as elements.

8. The print-job grouping apparatus according to claim 7, further comprising:
an identifying unit that identifies a demanded print quality of each of the component jobs as the quality condition,
wherein the grouping unit generates the plurality of group jobs by grouping together the plurality of component jobs in accordance with the demanded print quality of each of the component jobs and a guaranteed print quality guaranteed by each of the printers.

9. The print-job grouping apparatus according to claim 7, further comprising:
an identifying unit that identifies a demanded print quality of each of the component jobs as the quality condition and identifies a demanded number of print pages for each of the component jobs,
wherein the grouping unit generates the plurality of group jobs by grouping together the plurality of component jobs in accordance with the demanded print quality of each of the component jobs, the demanded number of print pages, and a guaranteed print quality according to a number of print pages guaranteed by each of the printers.

10. The print-job grouping apparatus according to claim 5, further comprising:
an acquiring unit that acquires, at every predetermined time period, the guaranteed print quality guaranteed by each of the printers.

11. The print-job grouping apparatus according to claim 6, further comprising:
an acquiring unit that acquires, at every predetermined time period, the guaranteed print quality according to the number of print pages guaranteed by each of the printers.

12. The print-job grouping apparatus according to claim 5,
wherein the identifying unit identifies the demanded print quality from a print attribute included in each print job.

13. The print-job grouping apparatus according to claim 5,
wherein the demanded print quality is input by an operator.

14. The print-job grouping apparatus according to claim 5, further comprising:
a memory that stores job information based on each print job; and
an adding unit that adds the demanded print quality identified by the identifying unit to the job information.

15. The print-job grouping apparatus according to claim 1, further comprising:
a converter that converts the group jobs generated by the grouping unit into one print job.

16. A print-job processing system comprising:
a plurality of printers that each perform a printing step;
a pre-processing apparatus that performs a pre-processing step previous to the printing step and to generate a plurality of group jobs by performing grouping based on a plurality of input print jobs in accordance with a grouping condition including a quality condition,
wherein each group job is processed by a printer selected from the plurality of printers, and
wherein the quality condition is a condition other than a general condition including a printing condition and is a special condition designated by a client requesting processing of each print job.

17. A non-transitory computer readable medium storing a program causing a computer to execute a print-job grouping process, the print-job grouping process comprising:
generating a plurality of group jobs by performing grouping based on a plurality of input print jobs in accordance with a grouping condition including a quality condition,
wherein each group job is processed by a printer selected from a plurality of printers, and
wherein the quality condition is a condition other than a general condition including a printing condition and is a special condition designated by a client requesting processing of each print job.
